(19) United States
(12) Patent Application Publication
(10) Pub. No.: US 2012/0005043 A1
(43) Pub. Date: Jan. 5, 2012

(54) SYSTEM AND METHOD FOR SALES AND DISTRIBUTION OF TICKETS TO FUTURE EVENTS

(75) Inventor: Shay Bushinsky, Ganei Tikva (IL)

(73) Assignees: Shay BUSHINSKY, Ganei Tikva (IL); D.O. BURIN CONSULTING & MANAGEMENT LTD, Herzlia (IL); Daniel REISNER, Tel Aviv (IL)

(21) Appl. No.: 13/256,248

(22) PCT Filed: Mar. 11, 2010
(86) PCT No.: PCT/IL2010/000207

§ 371 Date: Sep. 13, 2011

Related U.S. Application Data
(60) Provisional application No. 61/160,103, filed on Mar. 13, 2009.

(51) Int. Cl. G06Q 30/00

(52) U.S. Cl. 705/27.1; 705/1.1

(57) ABSTRACT

Methods and systems for tournament ticketing. A method of tournament ticketing includes: selling Nc tokens for each contestant c in a tournament, the tokens being redeemable for tickets to matches i of a particular contestant c in the tournament; and obtaining Ti tickets to each match i of the tournament.

### BACKGROUND

1. Technical Field

The present invention relates to a device, system and method for sales and distribution of tickets to future events having uncertain participants and/or uncertain location.

2. Description of Related Art

Many sporting events and other competitions involve several stages, whose participants and pairings are determined by their performance in previous stages. For example in knockout tournaments (which may be single elimination, double elimination, etc.) players losing a given number of matches are knocked out of the tournament, gradually narrowing the field. Similarly a Swiss-system group tournament (although generally not a round-robin) will have pairings dependent upon previous performance, with similarly-performing players being paired. For a variety of reasons these systems facilitate black- and grey-markets for ticket scalpers. For example the value of a quarter-final ticket sold in advance of the preceding round's results may increase suddenly in value once the participants of the quarter-final games are known. One might be able to obtain a Dubai tennis championships men's quarter final ticket for 500 Arab Emirates Dirhams before the tourney starts, but the ticket price may jump suddenly to 1000 AED if four well-known players or long-time rivals reach the quarter finals. This encourages scalpers to buy such tickets and resell them as the market value of the tickets fluctuate. Furthermore, spectators may not be able to attend their favorite teams' games due to skyrocketing prices and/or ticket unavailability. Scalping has further undesirable side effects (other than driving up prices) including counterfeit ticketing and possible organized-crime influence. Finally, due to the last-minute scramble to buy and sell tickets once participants are known, many ticket holders aren't able to sell their tickets, causing empty seats in the venues.

In many competitions the venue will also be determined by the outcome of certain matches; for example a match between two soccer teams in a tournament will often be held at one of the two soccer teams' home stadia, thus which teams are playing determines which stadia are involved.

The uncertainty regarding the venue engenders a similar situation to that depicted above with respect to prices for lodging near the venue, transport to/from the venue, and other related goods and services. If it is announced on a certain date that certain games of the 2010 FIFA World Cup will be held in Bloemfontein South Africa, prices for Bloemfontein lodging, rental cars, parking, flights, food, entertainment, real estate, liquor licenses, and the like may experience sudden increases, prompting speculators to reserve such goods and services for resale after prices change.

WO2007125529A3 “A system and a method for managing tickets sale for sport events” to Yaniv and Oren discloses centralized sale of tickets to tournament final games such that fans of the finalists' teams are able to purchase tickets at their original prices (the prices at the time of registration). A computerized web-based sales desk enables fans to secure an option to purchase tickets to the final games of a tournament and to see their favorite team in action, provided that their team has made it through to the final games. However there is no enablement given for pricing techniques that take into account the total number of teams and tournament structure. Furthermore '529 is silent on all the associated goods and services whose prices will fluctuate with venue and team.

Airlines have for some time based their ticket prices on roughly real-time analysis of demand. This however is no different in principle from any sales system that takes into account the normal variations of supply and demand. Premium game pricing has been announced e.g. for the San Francisco Giants, whereby more popular matchups (e.g. against the Boston Red Socks) are priced higher. However this again is simply a supply/demand system. In any case the system does not guarantee spectators seats during knockout or other tournaments. Furthermore as in '529, no treatment is given for associated goods and services whose prices will fluctuate with venue and team.

Hence, an improved method for providing options for tickets and associated goods and services is still a long felt need.

### BRIEF DESCRIPTION OF THE DRAWINGS

The present invention will be more readily understood from the detailed description of embodiments thereof made in conjunction with the accompanying drawings of which:

FIG. 1 presents a flowchart of the system's operation;

FIG. 2 Illustrates an example of the operation of a system consistent with an embodiment of the present invention;

FIG. 3 presents an example of an algorithm for operation of the system of the current invention; and FIG. 4 presents an example of an exchange display useful for a market for exchange of ticket commodities.

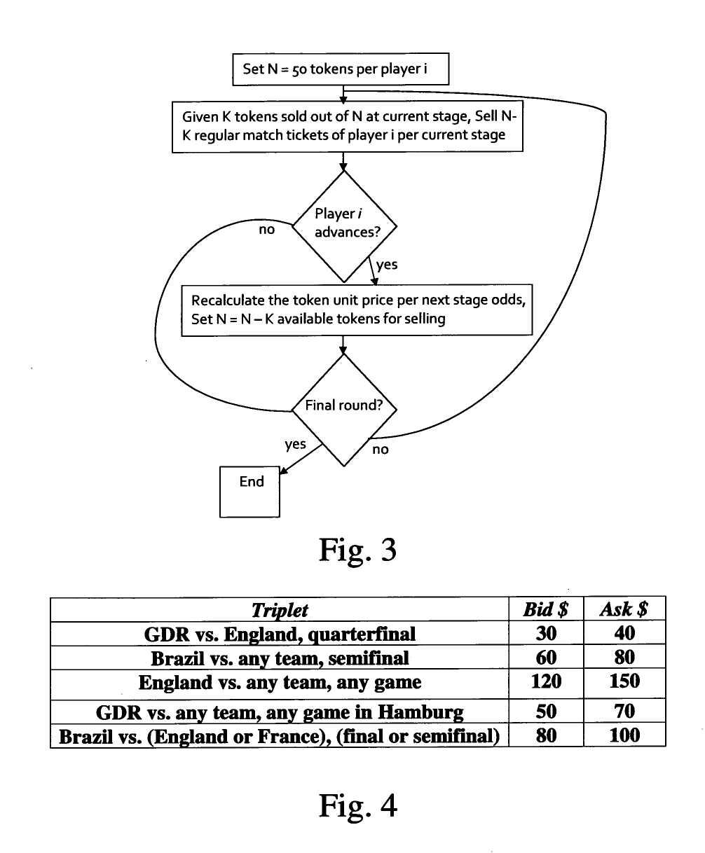

### BRIEF SUMMARY

One aspect of the present invention, a number 2N of tickets to a given game of a tournament are obtained or generated by the system operator. Tokens to buy tickets to see a particular team at this game are then sold to spectators. If this particular team makes it to the game in question, the spectator holding the token may obtain the ticket. Otherwise, the spectator loses whatever was spent purchasing the token. A maximum of N tokens are sold for each particular team, such that a total of KN tokens may be sold (where K is the number of teams that can possibly reach the game in question). The ticket cost may be fixed beforehand, such that it does not fluctuate with tournament results. The ticket cost may be included in the option cost, or may be sold separately allowing the option to be low priced. By means of this system, several advantages over current systems are obtained: spectators can be assured a seat at their favorite team's games (in the event that ‘their’ team reaches a given round); ticket prices are stabilized and scalping is minimized; and a profit is generated for the system operator.

Another aspect of the present invention provides tickets to tournaments comprising steps of:
a. selling N_{c} tokens for each contestant c in said tournament, said tokens being redeemable for tickets to all of the matches i of said contestant in said tournament;
b. obtaining Tᵢ tickets to each match i of said tournament.

Another aspect of the present invention provides the aforementioned method where said number of tickets Tᵢ is determined by the maximum pairwise sum of tokens sold, Tᵢ=max(Nⱼ+Nₖ) where Nⱼ, Nₖ are the number of tokens sold for teams j,k for all j,k where j≠k.

Another aspect of the present invention provides the aforementioned method where said number of tickets Tᵢ is determined by a function of said number of tokens sold N_{c} for contestant c and the probabilities of P_{c,i} of a given contestant c reaching match i of said tournament.

Another aspect of the present invention provides the aforementioned method wherein the cost of said token for each contestant is determined by a function of the probability of said contestant reaching a given round of said tournament.

It is further within provision of the invention to provide the aforementioned method wherein said function for the cost of said token is given by

$$T = {\sum }_{i = 1}^{{N}_{rounds}} {C}_{i} {P}_{i} {κ}_{i} ,$$

where N_{rounds} is the number of rounds in said tournament, Cᵢ is the cost of a ticket to a match of round i of said tournament, Pᵢ is the probability of said contestant reaching said round i of said tournament, and κᵢ is a profit margin.

Another aspect of the present invention provides the aforementioned method wherein said profit margin κᵢ is determined by means of a function of the probability P, and a constant α.

Another aspect of the present invention provides the aforementioned method additionally comprising a step of selling tickets arising from unsold tokens back to the venue operator, ticket seller, or individual spectators.

Another aspect of the present invention provides the aforementioned method additionally comprising the step of minimizing risk of loss by means of betting upon unlikely tournament outcomes.

Another aspect of the present invention provides the aforementioned method additionally comprising the step of minimizing risk of loss by means of betting upon likely tournament outcomes.

Another aspect of the present invention provides the aforementioned method wherein said tournament is selected from the group consisting of: soccer tournament, tennis tournament, golf tournament, chess tournament, poker tournament, horse racing tournament, football tournament, computer game tournament, auto racing tournament, bike racing tournament, basketball tournament, bowling tournament, boxing tournament, cricket tournament, curling tournament, hockey tournament, handball tournament, lacrosse tournament, martial art tournament, paintball tournament, remote-controlled elements tournament, rugby tournament, radio-controlled elements tournament, softball tournament, video games tournament and volleyball tournament.

Another aspect of the present invention provides the aforementioned method where said token is further redeemable for goods and services associated with said tournament.

Another aspect of the present invention provides the aforementioned method wherein said goods and services are selected from the group consisting of: hotel reservations, flight reservations, car rentals, shuttle services, restaurant reservations, in-game services and event reservations.

Another aspect of the present invention provides the aforementioned method further comprising steps of selling tokens for provision of goods and services to providers of said goods and services.

Another aspect of the present invention provides a smart ticket system for tournaments consisting of a set of Tᵢ actual tickets for each match i of said participant in said tournament, said Tᵢ actual tickets backing a set of N_{c} smart tickets sold for following contestant c, said N_{c} smart tickets entitling the bearer to attend all matches of said contestant c in said tournament.

Another aspect of the present invention provides the aforementioned system where said number of tickets Tᵢ is determined by the maximum pairwise sum of tokens sold, Tᵢ=max(Nⱼ+Nₖ) where Nⱼ, Nₖ are the number of tokens sold for teams j,k for all j,k where j≠k.

Another aspect of the present invention provides the aforementioned system where said number of tickets Tᵢ is determined by a function of said number of tokens sold N_{c} for contestant c and the probabilities of P_{c,i} of a given contestant c reaching match i of said tournament.

Another aspect of the present invention provides the aforementioned system wherein the cost of said token for each contestant is determined by a function of the probability of said contestant reaching a given round of said tournament.

Another aspect of the present invention provides the aforementioned system wherein said function for the cost of said token is given by

$$T = {\sum }_{i = 1}^{{N}_{rounds}} {C}_{i} {P}_{i} {κ}_{i} ,$$

where N_{rounds} is the number of rounds in said tournament, Cᵢ is the cost of a ticket to a match of round i of said tournament, Pᵢ is the probability of said contestant reaching said round i of said tournament, and κᵢ is a profit margin.

Another aspect of the present invention provides the aforementioned system wherein said profit margin κᵢ is determined by means of a function of the probability Pᵢ and a constant α.

Another aspect of the present invention provides the aforementioned system additionally comprising a step of selling tickets arising from unsold tokens back to the venue operator, ticket seller, or individual spectators.

Another aspect of the present invention provides the aforementioned system additionally comprising the step of minimizing risk of loss by means of betting upon unlikely tournament outcomes.

Another aspect of the present invention provides the aforementioned system additionally comprising the step of minimizing risk of loss by means of betting upon likely tournament outcomes.

Another aspect of the present invention provides the aforementioned system wherein said tournament is selected from the group consisting of: soccer tournament, tennis tournament, golf tournament, chess tournament, poker tournament, horse racing tournament, football tournament, computer game tournament, auto racing tournament, bike racing tournament, basketball tournament, bowling tournament, boxing tournament, cricket tournament, curling tournament, hockey tournament, handball tournament, lacrosse tournament, martial art tournament, paintball tournament, remote-controlled elements tournament, rugby tournament, radio-controlled elements tournament, softball tournament, video games tournament and volleyball tournament.

Another aspect of the present invention provides the aforementioned system where said token is further redeemable for goods and services associated with said tournament.

Still another aspect of the present invention provides the aforementioned system wherein said goods and services are selected from the group consisting of: hotel reservations, flight reservations, car rentals, shuttle services, restaurant reservations, in-game services and event reservations.

Yet another aspect of the present invention provides the aforementioned system further comprising steps of selling tokens for provision of goods and services to providers of said goods and services.

These, additional and/or other aspects and/or advantages of the present invention are: set forth in the detailed description which follows; possibly inferable from the detailed description; and/or learnable by practice of the present invention.

### DETAILED DESCRIPTION

Reference will now be made in detail to embodiments of the present invention, examples of which are illustrated in the accompanying drawings, wherein like reference numerals refer to the like elements throughout. The embodiments are described below to explain the present invention by referring to the figures.

The following description is provided, alongside all aspect of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing a system and method for sales and distribution of tickets to future events.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention.

The term ‘plurality’ refers hereinafter to any positive integer e.g, 1,5, or 10.

The term ‘ticket’ refers hereinafter to any spectator pass, participant pass, player pass, or team pass entitling the bearer to entrance to observe and/or participate in a given match.

The term ‘match’ refers hereinafter to a contest between one or more contestants, for example a single soccer game, or a set of soccer games between two teams to determine which team will advance to the next round of a tournament.

The terms ‘contestant’, ‘player’, and ‘participant’ refer hereinafter interchangeably to a player, team, contestant, or other participant in a tournament.

The term ‘tournament’ refers to a competition involving multiple matches, each involving some subset of the competitors, with the overall tournament winner determined based on the combined results of the individual matches. Team sports, racket sports, combat sports, many card games, board games and computer games, and the like may be played in tournament settings. Such tournaments allow large numbers to compete against each other in spite of restrictions on the number of participants in a single match.

The term ‘knockout tournament’ refers to a tournament in which players are eliminated at various stages of the tournament, depending upon their performance. For example in a single elimination or ‘sudden death’ tournament, participants are eliminated after a single loss.

The term ‘group tournament’ refers to a tournament in which each participant plays a fixed number of matches. A round-robin tournament has each player playing all other players, while a Swiss-system tournament has each player playing similarly-performing players.

The term ‘uncertain tournament’ refers to any tournament in which the participants or match pairings are unknown before the tournament or before a given round. For example the participants at any stage of a single-elimination knockout tournament are known only after the results of the previous stage are known. Similarly the pairings of the games of a Swiss-system tournament (other than the first round) are known only after the results of the previous round are in.

The term ‘token’ or ‘smart ticket’ refers to a marker, either physical or otherwise, redeemable by the holder for the purpose of buying or receiving tickets to a given set of matches for a given team, from a system operator. In particular a token could be generated electronically—e.g. by means of a keyword, confirmation code or an ID number.

In one simple embodiment of the invention, 2N tickets to a given game of a tournament are obtained or generated by the system operator. Options to buy these tickets are then sold to spectators or other interested parties, who buy options to see a particular team (or teams) at this game. If their chosen team makes it to the game (i.e. has not been eliminated from the tournament or otherwise been prevented from reaching this game), the spectator may exercise the option and buy or otherwise obtain his optioned ticket. A maximum of N ticket options are sold for each particular team. Since each game will generally have two contestants, 2N tickets must be obtained by the system operator to cover all the options sold. Thus if there are K contestants or teams that may possibly reach this game, a total of KN ticket options may be sold. The ticket cost may be fixed beforehand, such that it does not fluctuate with tournament results. The ticket cost may be included in the option cost, or may be sold separately. Obviously if each match involves other than two participants, the system may be trivially modified accordingly, as will be obvious to one skilled in the art. For example if each match involves M participants, then M×N tickets will be obtained by the system operator in a conservative embodiment of the invention, while K×N ticket options may still be sold.

By means of this system several advantages over current systems are obtained: spectators can be assured a seat at their favorite team's games (in the event that ‘their’ team reaches a given round); ticket prices are stabilized and scalping is minimized; and a profit is generated for the system operator.

It is within provision of the invention that tickets be provided for tournaments involving sports, board games, card games, computer games and the like including soccer tournaments, tennis tournaments, golf tournaments, basketball tournaments, and others using the inventive method.

As an example consider the FIFA soccer world cup. In this tournament 32 teams participate in a type of elimination tournament; teams compete in groups of four, out of which the first place and second place teams qualify to the 1/8 finals. Depending on the placing (first or second) in the first round, the 1/8 final round matchups and venues are determined. Many fans of each team would in principle come to watch these 1/8 final matches, but are not sure if their team will qualify until the end of the first round. Nor do they know where the venue will be.

To continue the example, after the first round FIFA announces that the first place in group 1 will play the second place in group 2 in Hamburg on the 12/7 at 8:30. If one buys the tickets for this game before the end of the first round, he/she does not know for certain who will be the teams playing in that stadium and will not know if he/she will be seated with other fans of his team of choice or will be seated with the opponent fans. Clearly this will have ramifications on hotel bookings, fan travel, and other associated goods and services, since (for instance) demand will spike for popular teams once the pairings are known. Consequently, some spectators gamble and buy tickets for the 1/8 final game that they believe may involve their team. If their team doesn't qualify or ends up playing somewhere else, they will often try to sell their tickets on the black market, usually to fans of the teams that did qualify to that stadium or intermediate scalpers. Other fans defer their buying until such point that the players and venues are known, at which point tickets are generally scarce and sold for great amounts.

As a result, some fans go home disappointed, as their team qualifies but no tickets are left for them, despite these fans' being willing to pay good money and to travel especially for the event from far away. For other fans, venue operators, team owners, and sporting organizations, frustration grows when there are vacant seats left in the stadium. These are the seats of fans of teams that didn't make it to this game; these fans might not manage to sell their tickets, or might not make a special effort to get rid of their tickets but didn't care to show up because their team didn't qualify.

The gray and black markets engendered by these situations drive ticket prices up, which often are sold at outrageous prices. The degree of uncertainty grows from one stage to another, as each stage introduces its own uncertainty. Thus the more prudent fans often simply wait until the results are in, and rush to get tickets in stadiums located in various cities, where the quarter finals, semifinals, and finals take place.

In one embodiment of the invention, an improved method is thus proposed, whereby instead of tickets being sold per game, a complete ticket series is offered, referred to hereafter as a “token” or “smart ticket”. The token entitles the buyer to tickets to any tournament game of his chosen team, wherever it may be. In one embodiment of the invention the ticket series includes the first round, 1/8 finals, quarter finals, semifinals, and finals. In other embodiments of the invention, these tokens are only redeemable for tickets of a given match such as the finals. In some embodiments of the invention the token is redeemable for a ticket for free, while in other embodiments the token is redeemable for a ticket for some fee.

### EXAMPLE 1

### World Cup Soccer Example

As an example we take the soccer world cup tournament, where usually 32 teams start. Assume 10,000 tokens are sold per team. Thus 320,000 tokens are sold in total. The tokens may be sold in differentiated tiers, such as gold, silver and bronze tokens, corresponding to the seat quality and other attributes. These tiers can be varied, for example including more tiers, as well as bundling other goods and services such as air travel, land travel, hotel accommodation, VIP access, and the like, as will be obvious to one skilled in the art.

In one embodiment of the invention the seats offered are grouped in such a way that fans of a given qualifying teams will be seated together. A fan buying his team's token, will receive an electronically marked token together with (for example) the three first tickets for his team qualification (first round) games. Later on, if the fans' team qualifies to subsequent stages, in one embodiment he may present this token at the stadium entrance and receive in return the appropriate class tickets for the game.

Obviously, variations on the method by which the fan is given entrance to the stadium may be employed. For example the fan may be given a confirmation code or other token (physical or data) that may be redeemed at the stadium entrance, ticket sales office, or over the internet, for entrance to the game or for receipt of a physical ticket. Use of a confirmation code instead of a physical ticket may be feasible since the probability of guessing a valid code can be made arbitrarily small. Alternatively a bar code may be printed that is also difficult to fake since the number of possible codes may be made enormous in comparison to the number of valid codes. The barcode can be shown via a mobile device such as a cellphone, and credited as a valid token. Variations upon these methods will be obvious to one skilled in the art, such as transmission of a validation code from a mobile device to a validation device using wireless means, production of an on-screen barcode or other pattern on a mobile device to be read by a validation device, and the like

We now continue the example above. The system operators or brokers who sell the tokens must buy against the 320,000 tokens sold, 20,000 tickets per game—10,000 for each team which makes it to each game. This ensures coverage of seats per a potential token holder.

Continuing with this example, the system operator would buy 20,000 tickets per game for each stage (qualification, 1/8 final, quarterfinal, semifinal, and final). After the qualification stage, the system operator has sold more tokens than tickets, as half the teams are knocked out of the competition. Thus for the 8 matches of the 1/8 final, the system operator provides 20,000 tickets per match for a total of 160,000 tickets, although he has sold 320,000 tokens. For the four quarterfinal matches he provides 80,000 tickets, for the two semifinal matches 40,000 tickets and in the finals, 20,000 tickets. In a sense the system operator has ‘oversold’ the games by large factors; for example, in the final match 20,000 tickets are actually distributed to the spectators, while 320,000 tokens (options) were sold, a factor of 16 over-sell (corresponding to the factor of 16 by which the field has narrowed).

At this point several advantages of this scheme should be apparent:

1. The customer is assured of following his team up to the finals, without worrying about scrambling at the last minute for tickets or dealing with scalpers or unknown internet entities.

2. Overall revenue is ensured for the system operator and venue operator, due to fewer unoccupied seats and multiple over-sells per seat. The over-sell is especially pronounced as fans are biased and tend to overestimate their team's chances and therefore will “gamble” that their team will reach high stages, increasing sales of tokens for teams with poor chances of advancement.

3. Fans of a given team may be grouped together in the stadium, ensuring a favorable distribution of spectators and help the law enforcement agencies to avoid or contain violence. In our example we have two 10,000 people groups per each game, which may be situated on opposite sides of the stadium. This is easy to arrange since the 20,000 tickets may be bought in large contiguous blocks or simply sold as ‘Liverpool side’ or ‘Chelsea side’ tickets.

4. Package deals including travel, lodging, food, tourist attractions and the like can be incorporated into each token.

5. A token may be auctioned or sold on a per team basis—with for example a favorite team token being auctioned or sold for more than an underdog team one.

6. The use of tokens enables flexibility in printing e-tickets via the internet or other network.

7. Tokens can be designed as memorabilia for the tournament using team colors, country flags, team history, etc.

### EXAMPLE 2

### Wimbledon Tennis tournament

The second example concerns the Wimbledon tennis tournament. These tennis tournaments use a knockout format where the players are initially seeded according to their world ranking and paired accordingly. The winner of each match proceeds to the next stage. This example shows how the method of the current invention can be applied to such tournaments. The basic idea again is for the ticket purchaser to buy a series “token” that enables him to follow his favorite player throughout the series, for as far as that player gets in the series. For example, a fan may buy a token to watch all of Maria Sherapovas' matches. Advantages to buying such a ticket are similar to those in the previous example, and are enumerated below.

The purchaser is guaranteed to have access to tickets to all of his/her games, regardless of the tournament stage she reaches, and independent of the stadium Sherapova ends up playing in. The cost for the entire package may be made cheaper than the cumulative regular ticket costs, due to the large amount of oversold tokens. The ticket cost has in a sense been spread over the entire base of fans who buy tokens, allowing the price for an individual token to be decreased. Finally, seating can be guaranteed amongst other Sherapova fans.

Other incentives can be attached that capitalize on personalization. For example, one may attach or bundle memorabilia with to the token such as a Sherapova picture, signature, passes to participate in a victory banquet, etc.

Fans whose favorites drop during early stages, do not end up with “useless tickets” they had to purchase in advance, in the event their favorite would reach the final stages.

The system operator can make a good profit from this method, due to multiple sales of the same seat. The possible yield for the broker is elaborated below. The organizers benefit as follows:
Stadiums will increase their attendance reliably.
Black market sales and scalping are discouraged.
Greater profits for the system operator can be generated, while lower ticket prices can be provided, since the price of the tickets is distributed over larger numbers of potential spectators.

Implementation

The method of the invention can be implemented in certain embodiments via an internet or intranet website, remote server and client side software or telephone service center. One or more such sales points may auction the tokens, for instance to highest bidders, or at fixed prices. Such fixed prices may be re-calculated at any given time due to time or event triggers. The website may be run by either the system operators themselves or via a ticket broker. The cooperation between the broker and the system operator can lead to improved package deals and “token personalization”. Since the organizers usually hold agreements with the players or teams as well as the system operators, this could add benefits to the token purchasers.

In one embodiment of the invention, a website may auction tokens using a floor or minimum price for each type of token (e.g. for each team), or each token individually (e.g. allowing for price variation during sales as demand fluctuates). The floor price will reflect the seating quality as well as the player's chances to win the tournament. Subsequent sections will explain specifically an enablement showing how the broker profit model can be designed.

The system may be implemented on a set of dedicated servers on the net, or on client-side software that users download from a networked location. Alternatively, the system may be implemented (for example) on servers belonging to travel agents, ticket brokers, ticket resellers, or the like. Another possible way to implement the system is through cellular phone messages such as SMS messages; the potential spectator would send (for example) a certain SMS message to a certain cellular phone number in order to buy or reserve tokens, and may in some embodiments then receive another SMS containing a confirmation number or barcode (for example) that may be presented at the stadium gate to allow entrance to the appropriate games.

As mentioned above, the tokens may be provided in the form of physical objects such as dongles or coins, or in the form of confirmation codes that the spectator receives through (for example) an SMS messages or email message. The spectator may alternatively receive electronic tickets with barcodes that can be cleared by a bar code reader.

The actual software running the system, which as will be explained below involves certain calculations and the requisition of actual tickets to back the tokens, will in general run on servers dedicated for this purpose.

Software employed by the system may in some implementations of the invention be broken into several modules, including a GUI, a calculating engine adapted to determine the number of tickets to buy depending on the number of tokens bought, odds, and other factors; a database of tickets bought and tokens bought; a communication module adapted to buy or otherwise obtain tickets; a communication module adapted to sell tokens to token buyers; and a module adapted to generate tokens, either by sending a confirmation number, printing a bar code or confirmation code, or sending communications to another device adapted to generate such tokens. Another module may link to hotel reservation system, travel agent computer, flight reservations and the like, and may be authorized to automatically generate reservations according to tokens purchased.

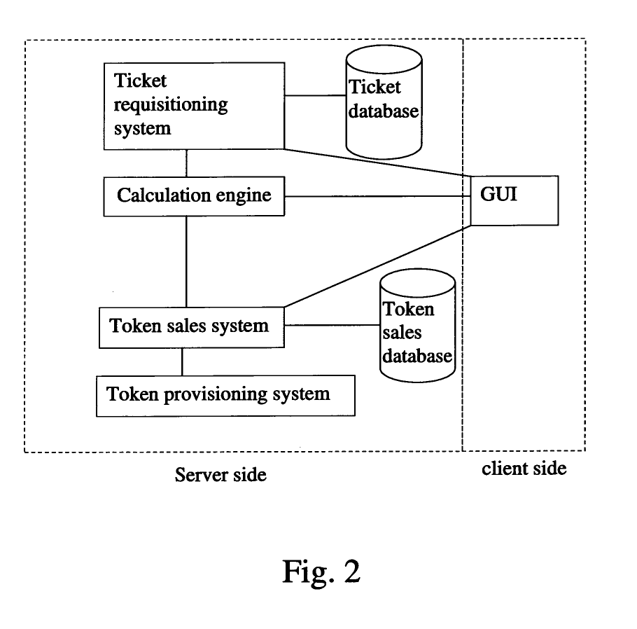

One possible architecture of an exemplary system is shown in FIG. 2, with the GUI running on the client side in communication with a calculation engine that runs on the server side and is in electronic communication with the other elements of the system, including a ticket requisitioning system that can buy or otherwise obtain match tickets, a token sales system adapted to sell the tokens, a token provision system adapted to send, print, or otherwise provide the tokens, and databases in communication with the token and ticket sales systems.

### EXAMPLE 3

### The Broker Profit Model

Let us assume there are 16 players or teams in a knockout competition: eight favorites with a probability of 1/8-ε for winning the tournament, and eight weaker players with a very low probability, for example 1/80, of winning the tournament.

It follows that:

a. The probability of a strong player defeating a weaker one is:

(1/8)/(1/8+1/80)=0.9

b. The probability of a weak player defeating a strong one is the complement:

1−0.9=0.1

Let us assume tournament ticket prices are set as follows:
A ticket to the 1/8 final costs $100
A ticket to the 1/4 final costs $200
A ticket to the 1/2 final costs $300
A ticket to the final costs $400

The broker purchases 100 tickets for each game. He strives to sell 50 tokens per player, where the tokens are good for tickets to all games of a particular player. This will come to a total of 16×50=800 tokens if all are sold. In this example, the tokens sold split into 400 “favorite tokens” and 400 “underdog tokens”. As will be obvious to one skilled in the art, the number of token classes is not limited to one or two (as in this example), but rather may take any value. For instance, a different class of token may be assigned for each player or team, in keeping with that player's or team's individual chances in the tournament.

The broker must secure 100 tickets (=2*50 tokens) for each of the games, as it is unknown which player will eventually qualify−he must reserve tickets for any of the spectators who purchased a token of a qualifying player. Obviously if fewer tokens are sold, fewer tickets may be required, as will be discussed later.

There are eight 1/8 final games, four 1/4 final games, two semifinal games, and one final. The broker must buy tickets for each of the eight 1/8 final games, four quarter final games, etc; thus the total expenses for the broker are:

100×($100×8 +$200×4+$300×2+$400)=$260,000.

The token pricing may now be determined per player class, in this example the two classes being favorites and non-favorites. We construct a table for the favorites below, showing the probabilities of reaching a given round for these players, a ‘profit coefficient’, a token sub-price for each round, and the actual final token price. The token sub-price is for purposes of calculation only, and in most embodiments of the system, is not a price offered to spectators.

TABLE 1
Favorites pricing chart

| | | Probability of | Token sub- | Profit |
|---|---|---|---|---|
| Stage | Ticket cost | reaching stage | price | coefficient κ |
| ⅛ final | $100 | 1 | $100 | 1 |
| Quarter final | $200 | 9/10 | $180 | 1 |
| Semifinal | $300 | 9/10*0.5 | $202.5 | 1.5 |
| Final | $400 | 9/10*0.5*0.5 | $135 | 1.5 |
| Total | $1,000 | | $637.5 | |

Thus a spectator can buy a token for the entire series for $637.5, whereas if he had bought the individual tickets for the same games, this would have cost $1,000. The pricing of the token is based on the sum of the per-match token ‘sub-prices’ (column 4 of the table). These are determined by multiplying the probability of reaching a given stage by the ticket price for that stage, then multiplying this by a further ‘profit coefficient’ κᵢ which expresses the desired profit of the broker. Thus the final token price T is determined by the ticket price Cᵢ for stage i, probability to reach stage i, and profit coefficient κᵢ for stage i as follows:

$$T = {\sum }_{i = 1}^{{N}_{rounds}} {C}_{i} {P}_{i} {κ}_{i}$$

The probabilities Pᵢ of favorite players to reach round i were determined in this example assuming that from the quarter final stage, strong players will meet strong players, giving each 50% chances to proceed. As will be obvious to one skilled in the art, these probabilities may be calculated individually for each player, and may take into account various factors such as the expected weather, player health and other player factors, opponent factors, venue factors, and the like.

As was mentioned above, the final token price has been kept significantly lower than the final series price. A spectator who buys the token for the series for a player who reaches the final saves the difference between the $1,000 series price and the $637.5 token price, or $100+$200+$300+$400−$637.5=$362.5

This savings can be guaranteed in one embodiment of the invention by keeping each round's token sub-price lower than that round's ticket price. This is easily done by adjusting each round's profit coefficient κᵢ to take into account that round's probability of occurrence for the player in question, such that the product Pᵢκᵢ remains lower than 1. In this example, the profit coefficient is based on the following step function with a as a parameter:

$${κ}_{i} = \{ \begin{matrix}1 , & if α {P}_{i} > 1 \\ α , & if α {P}_{i} \leq 1\end{matrix}$$

In other words, the profit coefficient κᵢ is set to 1 if α*Pᵢ exceeds 1, and is set to α otherwise. The value α=1.5 used in the example expresses the broker's profit margin.

As will be clear to one skilled in the art given the general method of the invention, different variations for determining the token sub-prices are possible. For example, the profit coefficient may be set to directly eliminate the effects of the probability Pᵢ,

$${κ}_{i} = \frac{α}{{P}_{i}}$$

where now the profit coefficient a is kept less than 1 by some percentage, which will cause the token price to be correspondingly less than the total series price. In this case a expresses the fraction of the maximum possible profit margin (assuming the broker wants to keep the token price less than the total series price.) Mathematically this works out as:

$$T = {\sum }_{i = 1}^{{N}_{rounds}} {C}_{i} {P}_{i} {κ}_{i} = {C}_{i} α$$

And it is clear that if e.g. α=0.8, then the token price will be 80% of the total series price.

In the case of an “underdog player” the corresponding table is:

TABLE 2
Underdogs pricing chart

| | | Probability of | Token sub- | Profit |
|---|---|---|---|---|
| Stage | Ticket cost | reaching stage | price | coefficient κ |
| ⅛ final | $100 | 1 | $100 | 1 |
| Quarter final | $200 | 1/10 | $30 | 1.5 |
| Semifinal | $300 | 1/10* 1/10 | $15 | 5 |
| Final | $400 | 1/10* 1/10* 1/10 | $20 | 50 |
| Total | $1000 | | $165 | |

From the quarter final stage, it is assumed that weak players will meet strong players, thus each has a 10% chance to continue to the next round. In this example the profit coefficient κ is based on the following step function with α as a parameter:

$${κ}_{i} = \{ \begin{matrix}1 , & if α {P}_{i} > 1 \\ \frac{0.05}{{P}_{i}} , & if α {P}_{i} < 0.05 \\ α , & otherwise\end{matrix}$$

In other words, the profit margin κ is set to 1.00 if α*Pᵢ exceeds 1.0, to 0.05/Pᵢ if α*Pᵢ drops under 0.05, and is set to a otherwise. The model in this example is based on the profit margin coefficient Alpha=1.5. As before, alternate methods and variations for determining the token prices will be obvious to one skilled in the art, given the general method of the invention.

In this case, a spectator who bought a token for all of a favorite underdog's games would save $100+$200+$300+$400−$165=$835, assuming the underdog makes it to the final.

The profit seen by the broker may be analyzed as follows.

Scenario 1: Selling All of the Tokens

This is the optimal scenario, in which the broker manages to sell all of the tokens for all players. Thus the broker's revenue will derive from 50 favorite tokens for the eight favorite players at $637.5 each, and 50 underdog tickets for the eight underdog players at $165, for a total of:

8×50×$637.5+8×50×$165=$255,000+$66,000=$321,000

Thus the operator's expected profit will be the revenue less the ticket expense,

Profit=$321,000−$260,000=$61,000

This expected profit is risk free and linear with the number of tokens sold, as shown in the following table.

TABLE 3
Expected profit as function of tokens sold

| Number of tickets | Tokens sold per | |
|---|---|---|
| per game | player | Expected profit |
| 100 | 50 | $61,000 |
| 200 | 100 | $122,000 |
| 300 | 150 | $183,000 |

The following chart shows the results of varying a, the profit coefficient: (assuming 100 tickets per game):

TABLE 4
Profit as function of α

| A | Expected profit |
|---|---|
| 1 | $4,000 |
| 1.25 | $36,000 |
| 1.5 | $61,000 |
| 1.75 | $85,500 |
| 2 | $110,000 |

Scenario 2: Selling Only Favorites Tokens

In this case, it is assumed that the broker manages to sell just the tokens of the favorites (despite the relatively low price of the underdog tokens). The revenue from selling the tokens of the 8 favorites would be:

8×50×$637.5=$255,000

At this point the broker is stuck with eight player's worth of unsold 1/8 final tickets, since only the 8 favorite's tokens were sold while 16 player's worth of tickets were bought. These tickets can still be sold individually as regular single-match tickets, for example at no profit, for a revenue of

8×50×$100=$40,000

In this scenario the broker still profits:

$255,000+$40,000−$260,000=$35,000

Never the less if the favorites do qualify these tickets must be supplied to the token owners and could not be resold which are effectively a risk taken by the broker in this system.

In similar fashion the broker can earn more money by cashing back tickets (selling back to the venue, ticket provider, or individual spectators) for the quarter final, semi-final and final, depending on the results of the 1/8 final games.
Sub Scenario 2.1: Only Favorites Qualify

In this case the broker can't cash back any tickets, as he needs to hold them against the favorite tokens sold.
Sub Scenario 2.2: Some of the Underdogs Qualify

In this case the broker can cash the tickets held against the favorite tokens which have been knocked out, or start a new sales effort of underdog tokens according to the broker model update scheme (see below). As will be clear to one skilled in the art, the method of the invention may be applied recursively; any newly available tickets (tickets which have been bought by the system operator but which have not had tokens bought against them) may be sold again by using the method of the invention, where all subsequent games for a given underdog that has unexpectedly made it to a given round, are sold by means of a token. Obviously this recursive use of the system is not limited to underdogs but may be employed to sell tokens against any tickets that become available due to tournament developments.

Scenario 3: Spectators Bought Only Underdog Tokens, and All the Underdogs Qualify

This is the worst case scenario for the broker. The broker's revenue will be:

8×50×$165=$66,000

for the tokens sold.

The rest of the 1/8 final favorite game tickets could again be sold as regular ones (perhaps without a profit) e.g.:

8×50×$100=$40,000

The broker will then be in the red:

$40,000+$66,000−$260,000=-$154,000

Although the third scenario is unlikely, it still bears a certain risk for the broker. However, hedging against the worst scenario is possible. For example, the broker can insure himself by betting part of the 1/8 final income on the underdogs winning. Alternatively, the broker can simply rely on the statistical advantage he has if his reserves are large enough; when averaged over many tournaments, it becomes more and more likely for the broker to profit the expectated value, just as a casino benefits from a slight profit margin over many individual games, any one of which may constitute a loss for the house but which statistically will tend towards the expected profit as the number of games increases. Another option for the operator is to dynamically adjust the token prices according to sales, starting with a high profit margin and gradually adjusting it according to sales. In principle the system operator can wait until tokens are sold before buying tickets, for instance buying or reserving a single series of tickets immediately upon sales of a single token. A further possibility is to sell tokens in ‘chunks’—for example for the first chunk, the system operator sells 4 tokens per team, and only after this chunk has been bought, the operator buys tickets to cover these tokens, and meanwhile begins selling the next chunk of tokens.

In one aspect of the invention the broker or system operator charges enough money so that given the participant performance percentages, regardless of what people decide to buy, the operator will be exposed to a minimal risk. In the optimal case all tokens will be sold, leaving the broker indifferent as to who wins and with no risk. The system operator can actually charge somewhat more than would otherwise be justified given the ticket prices and a player's chances, for several reasons. The first reason is due to fan psychology. If a given participant has for example a 10% chance of reaching a certain game whose ticket cost is $100, there would be a ‘justified’ cost of $10 for the option to this ticket, in the event that the participant reaches this game. However since fans often tend to overestimate their favorite team's or player's chances, they will generally be willing to ‘bet’ against the broker, purchasing with a given option at a premium over the actual percentage value attached to their team, as calculated for example according to its qualification odds; thus for example a fan may be willing to pay $15 for the option mentioned above, which may be viewed as a 10% ‘bet’ on a $100 ‘jackpot’. The second reason a fan may be willing to pay this premium, is that as shown above, the option price for a series of games, even when purchased at a premium, will in many cases actually work out to cost significantly less than the total sum of tickets if purchased individually. As mentioned before, this is due to the token price being spread over all the fans buying tokens, while the number of tickets necessary to cover these tokens remains fixed. KN fans may have bought an option on a particular seat at a particular game, while only 2N tickets must be actually provided by the system operator, where K is the number of teams possibly arriving at a particular game.

Updating the Broker's Model (Recursively)

The following section deals with the case that the broker manages to sell only part of the tokens for a given player who advances to the next stage. The broker can sell the current stage tickets he purchased to cover for the unsold tokens, and offer the unsold tokens to the public at a new price for the rest of the tournament.

Thus in certain embodiments of the invention the broker can operate the system by means exemplified by the following algorithm, which may be generalized as will be obvious to one skilled in the art:

```
Set N = 50 tokens per player i
Loop until final stage {
  Given K tokens sold out of N at current stage
  Sell N−K regular match tickets of player i per current stage
  IF (Player i advances to the next stage) {
    Recalculate the token unit price per next stage odds
    Set N = N − K available tokens for selling
  }
}
```

### EXAMPLE 4

### Illustration of a Broker Model Update

Assume a tennis tournament is held with 16 players. Again the top eight favorites are assigned initial odds of 1/8-ε for winning the tournament, while the bottom eight are given 1/80 odds of winning. As before, when c is negligibly small it is left out of the calculations.

Assume that the top seed plays his 1/8 final match against the lowest seed, the second seed plays against the second last seed and so forth. The following table summarizes the broker's model prior to the 1/8 final round and after the round it is updated according to the results.

TABLE 5
Tournament table

| | Prob- | | | | | | |
|---|---|---|---|---|---|---|---|
| | ability | | | | | | New |
| | of | Tokens | Unit | | Next | New | unit |
| Player | winning | sold | price | Qualified? | opponent | odds | price |
| 1 | 1/8 | 50 | 637.5 | Yes | 13 | 1/6 | N/A |
| 2 | 1/8 | 50 | 637.5 | Yes | 9 | 1/6 | N/A |
| 3 | 1/8 | 50 | 637.5 | Yes | 7 | 1/6 | N/A |
| 4 | 1/8 | 50 | 637.5 | No | | | |
| 5 | 1/8 | 30 | 637.5 | Yes | 6 | 1/6 | 575 |
| 6 | 1/8 | 30 | 637.5 | Yes | 5 | 1/6 | 575 |
| 7 | 1/8 | 30 | 637.5 | Yes | 3 | 1/6 | 575 |
| 8 | 1/8 | 30 | 637.5 | No | | | |
| 9 | 1/80 | 50 | 165 | Yes | 2 | 1/30 | 575 |
| 10 | 1/80 | 50 | 165 | No | | | |
| 11 | 1/80 | 50 | 165 | No | | | |
| 12 | 1/80 | 50 | 165 | No | | | |
| 13 | 1/80 | 10 | 165 | Yes | 1 | 1/30 | 265 |
| 14 | 1/80 | 10 | 165 | No | | | |
| 15 | 1/80 | 10 | 165 | No | | | |
| 16 | 1/80 | 10 | 165 | No | | | |

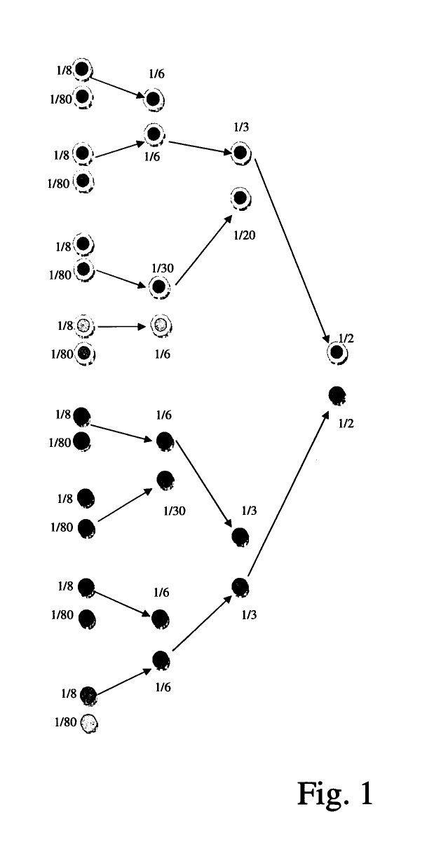

In this table the ‘qualified’ column states which players managed to proceed to the quarter finals. These results are also illustrated in FIG. 1, where the expected probabilities for a player to reach a given round are shown at each stage.

In this example the broker sold all of the 50 tokens for players 1-4, 30 tokens for players 5-8, all 50 tokens for players 9-12 and 10 tokens for 13 through 16.

Thus the broker's revenue is:

(50×4+30×4)×$637.5=$204,000 from favorite tokens

(50×4+10×4)×$165.0=$39,600 from underdog tokens

He also sells single game tickets for those 1/8 games for which not all the tokens were sold, these numbering 20 tokens for players 5-8, and 40 for players 13-16): his revenue is:

(20+40)×4×$100=$24,000

In this example players: 1, 2, 3, 5, 6, 7, 9, 13 make it to the quarter finals.

The broker sold all of the tokens for players: 1,2,3,9 so he cannot sell these again.

Next, he evaluates the cost of the spare tokens for player 5,6,7 and 13. Each token consists of a reduced series including the quarter final, semi final and final.

We assume the quarter final games will be: 1-13, 2-9, 3-7, 5-6.

The modified odds for the quarter finals are now 1/6, 1/6, 1/6, 1/6, 1/6, 1/6, 1/30, 1/30.

Player 13 will always play a top seed. So the chances of him winning a given match are 1/10. Therefore, the new cost for his token is set as follows:

$200 (will play in the quarter final)+0.15×$300 (10% for reaching the next stage times alpha=1.5, the broker's profit margin)+0.05×$400. This 0.05 probability is set to a floor of 0.05−the assumption being that a player never has less than 0.05 chance of winning due to luck. This works out to a total of $265. Notice that his token price went up.

Although there are no tokens left for player 1, for the sake of demonstration his updated token price would have been:

$200 (as he reached the quarter final)+$300 (almost certain to reach the semi final)+0.90×$400 (given 60% to win the semi game if he reaches it times Alpha=1.5) for a total of $860.

The cost for 5's token is updated accordingly:

$200+0.75×$300 (has 50% chance of reaching the semi times α=1.5)+0.375×$400 for a total price of $575.

Note the large difference between the prices of player 1's token and player 5's, due to the fact that player 1 had an easy first game and player 5 did not. The broker will now attempt to sell the tokens left according to the new prices. If he doesn't manage to sell them, he again will try to sell individual quarter final tickets and continue along the same update algorithm.

### EXAMPLE 5

### World Cup Soccer Championships

In one embodiment of the invention, the system operator or ticket broker lets the customer choose if he wants to pay for the option or for the “smart ticket” (token). If he pays for the option, this ensures that he will have all the tickets, risk free. If he pays for the “smart ticket” he is in a sense betting that his team will perform better than what the broker has calculated.

For example we again take the soccer world cup. We assume that the world soccer cup involves 32 teams, initially split into groups of 4.

Each team will have three games in the preliminary “house” stage, with a cost of $200 each per game. Two teams qualify from each house so there are sixteen qualifying teams. 1/8 final tickets cost $200, quarter final tickets cost $200, semi final tickets cost $300, and final tickets cost $1000. Again assume 16 underdog teams, and 16 favored teams.

In this example we simplify the broker profit model by adding a fixed premium cost of say $200 in return for the service of reserving customer tickets up to the finals.

Cost for underdog teams: $600 (three house games at $200 each)+$200 (profit for system operator)

Cost for favorite teams: $600 (three house games)+$200 (eighth finals ticket)+0.5*$200 (quarter final ticket)+0.25*$300 (semifinal)+0.125*$1,000 (final)+200 (for system operator)=$1,300

The potential ticket cost for a fan if the team makes the final is 600+200+200+300+1000 for a total of $2300, thus the actual smart ticket price of $1300 allows the fans excellent savings.

The total cost of tickets for the system operator is =2*(3*16*$200+8*$200+4*$200+2*$300+$1,000)=$27,200

Selling these tickets for 16*$1,300+16*$800=$33,600 allows for a profit of 20%.

This will still be a good deal both to buyers of good and bad teams, as each sees a savings over the cost of buying the series tickets individually.

The broker may also decide to simply sell any un-optioned tickets for the convenience of having all the tickets sold for $200.

It is within provision of the invention to provide, instead of tokens redeemable for the entirety of a contestant's matches, tokens redeemable for specific rounds or matches of a given tourney. For example, one can buy a token specifically redeemable for the quarterfinal of Spain in the Soccer World Cup, in the case that Spain makes it to the quarterfinal.

It is within provision of the invention that various alternate implementations be employed as will be obvious to one skilled in the art. For example, tokens may be sold that allow the bearer to follow several tournament participants instead of just one. Thus for example a token may be sold that allows the bearer to follow both Bahrain and Iran through the World Cup, and should either or both reach a given match, the bearer is entitled to one or two tickets to each such match.

It is further within provision of the invention to provide for events having any number of participants in a given match, for example one, two, or five. Thus for example in the World Series of Poker (WSOP) there are often 5 or more participants in a given match. In this case the number of tickets the system operator must obtain will not be twice the number of tokens sold but rather will reflect the number of participants per match. Therefore in a five-person poker table the system operator would have to buy five times the number of tokens sold worth of tickets.

It is further within provision of the invention that the system operator sell tokens not simply for observation of a given match but rather for participation therein. For example given poker players in the WSOP may decide to sell their seats at various stages of the tournament. Alternatively the event organizer may decide to offer seats at various tables and matches during the tournament. Thus it is within provision of the invention that such seats may be obtained by the system operator and sold.

As a further example of this embodiment of the invention, consider the massively multiplayer online role-playing game or MMORPG. Such games have reached such levels of popularity for example in S. Korea that they have become spectator sports, with fans of famous players simply watching their favorite players' progress. Thus tokens may be sold to follow a particular player, for example from a certain perspective not available to most viewers. However tokens may also be sold to join a particular band of players or team at a particular stage of the game; thus the tokens may allow the holder the right not just to spectate at, but also in principle to participate in, a given match, campaign, or journey.

It is within provision of the invention that tokens be sold not just to spectators and participants but also to providers of goods and services. For example a given rental car company in Pakistan may be interested in getting all the business of the token holders, should Pakistan's cricket team reach a given round of a high level tournament. The system operator may sell tokens to one or more such rental car companies that entitle them to a certain number of car rentals. If the Pakistan cricket team indeed reaches a given level of the tournament, then the rental token holders are entitled to the agreed-upon number of rentals (deriving for instance from the fans to whom spectator tokens are sold). If Pakistan is knocked out of this round however, then the rental token holders are not so entitled. As should be clear from the example, tokens may be sold to providers of other goods and services in this fashion, including hotel rentals, restaurant patronage, catering services, night club visits, and the like.

A further set of embodiments of the invention is based upon the fact that it is not always necessary to buy all of the 2N (or FN where F is the number of participants per match) tickets. For example, let us take again the soccer World Cup. The system operator has successfully sold several thousand tokens good for following several teams, as listed below. These teams start the Cup in the same group of four, such that only two will advance to the 1/8 finals.

Group of four teams matched in first round of Soccer World Cup

| | | Probability of advancing to |
|---|---|---|
| Team | Tokens Sold | next round |
| Egypt | 5000 | 0.3 |
| Israel | 6000 | 0.5 |
| Saudi Arabia | 7000 | 0.1 |
| Algeria | 8000 | 0.1 |

In this case the maximum possible number of token holders for the next round's match is 7000+8000=15000, less than the 2N that would be the case if equal numbers of tokens were sold to each team; this number of tickets is just the maximum pairwise sum

max(Nⱼ+Nₖ)

where Nⱼ, Nₖ are the numbers of tokens sold for teams j,k for all j,k where j≠k.

It will be further appreciated that the system operator may buy somewhat less than the ‘required’ number of tickets if he is willing to buy tickets at later stages. The system operator may wait for instance until the first round of a competition has finished in order to more intelligently buy the tickets required to back the tokens; for example if Algeria and Egypt are eliminated in the first round, then the system operator has only to buy 6000+7000=13,000 tickets for the next match since this is the new maximum number of token holders for the next round.

The system operator may furthermore buy for instance just 11,000 tickets before the first round, under the assumption that neither Algeria nor Saudia will not pass the first round, due to their low probabilities (0.1 in the table) of advancement.

As will be clear to one skilled in the art a more sophisticated approach is possible wherein one takes into account the probabilities for each team to advance, for example calculating the average expected number of token holders at a given match. Then the system operator may buy this average expected number or some function thereof, possibly incorporating the standard deviations of the expected performances. Obviously this will introduce risk to the operator as he may have to buy extra tickets to back up tokens in the case that (for example) a heavily-bought but poorly-seeded team in fact advances. However this risk may be balanced by calculating the expected cost of the extra tickets and comparing this to the expected revenue generated by overselling tokens in this manner, and/or by incorporating knowledge of the standard deviations of historical participant performance, and/or by betting upon unlikely outcomes as mentioned above.

Thus if N_{c} tokens are sold for each contestant c in the tournament, and the system operator obtains Tᵢ tickets to each match i of said tournament, Tᵢ may be determined conservatively by the maximum pairwise sum of tokens sold, Tᵢ=max(Nⱼ+Nₖ) where Nⱼ, Nₖ are the numbers of tokens sold for teams j,k for all j,k where j≠k. The number of tickets Tᵢ may be determined less conservatively by taking into account the probabilities of a given team reaching a given round. Thus a function of the number of tokens sold N_{c} for contestant c and the probabilities of P_{c,i} of a given contestant c reaching match i of said tournament can be used. For example, the Tᵢ may be calculated as

$${T}_{i} = {\sum }_{c = 1}^{K} {P}_{c , i} {N}_{c}$$

It is within provision of the invention that the ideas disclosed above be extended to comprise a stock exchange derivative model, as will now be described.

A virtual stock exchange can be implemented where tournament token owners, who have bought ‘tokens for a given tournament or part thereof, can buy and sell tournament ‘fragments’ such as options for tickets to attend particular games.

For example assume that a person has purchased a token for Brazil, for all of its tournament games.

Note that this token owner is now able to offer the following options:
Brazil vs. England in the final
Brazil vs. {England or France} in the final
Brazil vs. {Anyone} in the semi-final
Brazil vs {Anyone} in Hamburg
Brazil vs. Argentina, anywhere

Note the above games may not actually happen, but since the token owner had purchased in advance all of Brazil games, he has rights to the tickets if the games do happen.

Here is how one embodiment of the general method could work:
A. The broker buys any number of tickets for any selection of games.
B. The buyer selects a combination of games he would like to see—a combination of triplets “team1 vs. team2 at game3”.
Note B1: It's important to select the game as well, since the location and time where team1 will play vs. team2 in an intermediate stage may depend on how well each team did in the initial stages, whereas the ticket bought by the broker will be for a specific game (time, location) regardless of which teams reach that game.

Note B2: In practice, the broker may reduce complexity by offering pre-packaged combinations. One such combination is of course the “series ticket” described above, which is equivalent to an option for all triplets with “team1” in it. Another trivial combination is the standard ticket—“final game, no matter who plays”. Other combinations could be offered to fans of certain teams, for example England, Brazil, or Italy in the semifinals. Yet another possibility is for a set of games regardless of players, such as “series+final game”. The point is that the broker can now have increased flexibility. For example instead of selling a full series ticket for team1, an almost-full one may be sold, for example for all the games of team1, unless team1 plays against team5 in game11. The price for that combination may be set at a different amount, due to its lower availability, higher probability of occurrence, higher popularity, or the like.

It is within provision of the invention to provide an algorithm adapted to develop software which finds combinations which are likely to be requested by the public, and selects pricing for each, while maximizing the chance that it would be possible to create valuable combinations out of the “triplets” which haven't yet been sold.

C. The buyer can later transfer any part of the triplets covered by his ticket to anybody else.
Note Cb 1: One proposed mechanism is to give away “empty tickets” (or sell for low prices, or sell for higher price empty tickets with specialized options such as official team logos; these tickets may have advertising space which may also be sold to advertisers). The tickets could take the form of a physical “smart card” with active or passive RFID, or a piece of paper with unique bar code, or a code or software residing on a cell phone. A web site, physical site, or telepresence would be provided for “provisioning” a ticket by paying for selected options (e.g. a series ticket, a certain triplet as described above, or any other combination of options). The provisioning site will also be able to support transfer of options from one ticket to another. It may even offer to buy back some options (e.g. a holder of a series ticket for team1 may be told that a fan of team2 is willing to pay a lot of money for the “ticket slice” if team1 plays vs. team2 in game3). This will encourage trading and even “micro-trading”(trading in highly specific options), while creating some revenue from this trading (via a service charge for facilitating such transfers).

These smart tickets may be used in several ways to gain actual admittance to a game. If the official managers/promoters of the games cooperate, they will examine the smart ticket, and let the holder in as appropriate. If not, the system operator or broker can set up a booth or other physical location where the smart ticket (the one managed by the broker) is exchanged for an official ticket.

Triples may be denoted “team1 vs. team2 at game 3”, or “A vs. B@i”. Using this notation the ‘token stock exchange’ can be described as a method for tournament ticketing comprising steps of:
a. obtaining Tᵢ tickets to each match i of said tournament;
b. selling tokens for sets S of event triples {A vs. B @i} of said tournament, said event triples consisting of participants A and B playing each other in match i,
c. redeeming said tokens for tickets to those matches i occurring in said sets S of said event triples of said tournament.

As described above, the sets of event triples may be of the form {any team vs. any team@round i}, or {any team vs. team A@any round}, or {any team vs. any team@venue i}—thus the match i may refer to a particular round, or to a match at a particular venue i. To this point what is described is basically the original ticket token system described before.

The ‘exchange’ comes in when the system operator allows token holders to sell their tokens back by buying them, and then reselling them (possibly in different sets of triples). Thus the system comprises further steps of
d. buying tokens for sets of event triples from token holders;
e. reselling tokens for sets of event triples to token holders.

In FIG. 4 an example of a display screen operated by the exchange is shown. On this display given commodities are shown which consist of triples (team A vs. team B at game X, or team A vs. team B at venue Y) or sets of triples. A ‘bid’ and ‘ask’ column indicate prices that spectators or other ticket or option holders are willing to pay or sell for the various commodities listed. The exchange operator can charge some overhead for operation of the system as well as participating in selling and/or buying various commodities.

Although selected embodiments and examples of the present invention have been shown and described, it is to be understood the present invention is not limited to the described embodiments. Instead, it is to be appreciated that changes may be made to these embodiments without departing from the principles and spirit of the invention and aspects of each example can be combined or detached to any example or each change in these embodiments, the scope of which is defined by the claims and the equivalents thereof.

1-37. (canceled)

38. A method for tournament ticketing, comprising:
a. selling N_{c} tokens for each contestant c in said tournament, said tokens being redeemable for tickets to all of the matches i of said contestant c in said tournament;
b. obtaining Tᵢ tickets to each match i of said tournament, where Tᵢ is determined by the maximum pairwise sum of tokens sold, Tᵢ=max(Nⱼ+Nₖ) where Nⱼ, Nₖ are the number of tokens sold for teams j,k for all j,k where j≠k.

39. The method of claim 38 where said number of tickets Tᵢ is determined by a function of said number of tokens sold N_{c} for contestant c and the probabilities of P_{c,i} of a given contestant c reaching match i of said tournament.

40. The method of claim 38 wherein said function for the cost of said token is given by
$$T = {\sum }_{i = 1}^{{N}_{rounds}} {C}_{i} {P}_{i} {κ}_{i} ,$$
where N_{rounds} is the number of rounds in said tournament, Cᵢ is the cost of a ticket to a match of round i of said tournament, Pᵢ is the probability of said contestant reaching said round i of said tournament, and κᵢ is a profit margin.

41. The method of claim 38 wherein said ticket cost Ci is determined based upon seating, neighbors, and amenities.

42. The method of claim 38 wherein said profit margin κᵢ is determined by means of a function of the probability Pi and a constant α.

43. The method of claim 38 further comprising selling tickets arising from unsold tokens back to the venue operator, ticket seller, or individual spectators.

44. The method of claim 38 further comprising minimizing the risk of loss by means of betting upon unlikely tournament outcomes.

45. The method of claim 38 further comprising minimizing the risk of loss by means of betting upon likely tournament outcomes.

46. The method of claim 38 wherein said tournament is selected from the group consisting of: soccer tournament, tennis tournament, golf tournament, chess tournament, poker tournament, horse racing tournament, football tournament, computer game tournament, auto racing tournament, bike racing tournament, basketball tournament, bowling tournament, boxing tournament, cricket tournament, curling tournament, hockey tournament, handball tournament, lacrosse tournament, martial art tournament, paintball tournament, remote-controlled elements tournament, rugby tournament, radio-controlled elements tournament, softball tournament, video games tournament and volleyball tournament.

47. The method of claim 38 wherein said token is further redeemable for goods and services associated with said tournament.

48. The method of claim 38 wherein said goods and services are selected from the group consisting of: hotel reservations, flight reservations, car rentals, shuttle services, restaurant reservations, in-game services and event reservations.

49. The method of claim 38 further comprising steps of selling tokens for provision of goods and services to providers of said goods and services.

50. A method of tournament ticketing, comprising:
a. obtaining tickets to matches of a tournament;
b. selling tokens for sets of event triples of a tournament, said event triples consisting of certain participants playing each other in a certain match, where the number of tickets obtained is equal to the maximum pairwise sum of tokens sold; and
c. redeeming said tokens for tickets to those matches occurring in said sets of said event triples of said tournament.

51. The method of claim 50 further comprising:
a. buying tokens for sets of event triples from token holders; and
b. reselling tokens for sets of event triples to token holders.

52. The method of claim 50 wherein said match is selected from the group consisting of: a particular round of said tournament, a particular venue of said tournament, and a particular round at a particular venue of said tournament.

53. The system of claim 50 where said number of tickets Tᵢ is determined by the maximum pairwise sum of tokens sold, Tᵢ=max(Nⱼ+Nₖ) where Nⱼ, Nₖ are the number of tokens sold for teams j,k for all j,k where j≠k.

54. The system of claim 50 where said number of tickets Tᵢ is determined by a function of said number of tokens sold N_{c} for contestant c and the probabilities of P_{c,i} of a given contestant c reaching match i of said tournament.

55. The system of claim 50 wherein a function is determined for the cost of said token given by
$$T = {\sum }_{i = 1}^{{N}_{rounds}} {C}_{i} {P}_{i} {κ}_{i} ,$$
where N_{rounds} is the number of rounds in said tournament, Cᵢ is the cost of a ticket to a match of round i of said tournament, Pᵢ is the probability of said contestant reaching said round i of said tournament, and κᵢ is a profit margin.

56. The system of claim 55 wherein said ticket cost Ci is determined based upon seating, neighbors, and amenities.

57. The system of claim 55 wherein said profit margin κᵢ is determined by means of a function of the probability Pi and a constant α.

58. The system of claim 50 further comprising selling tickets arising from unsold tokens back to the venue operator, ticket seller, or individual spectators.

59. The system of claim 50 additionally comprising the step of minimizing risk of loss by means of betting upon unlikely tournament outcomes.

60. The system of claim 50 additionally comprising the step of minimizing risk of loss by means of betting upon likely tournament outcomes.

61. The system of claim 50 wherein said tournament is selected from the group consisting of: soccer tournament, tennis tournament, golf tournament, chess tournament, poker tournament, horse racing tournament, football tournament, computer game tournament, auto racing tournament, bike racing tournament, basketball tournament, bowling tournament, boxing tournament, cricket tournament, curling tournament, hockey tournament, handball tournament, lacrosse tournament, martial art tournament, paintball tournament, remote-controlled elements tournament, rugby tournament, radio-controlled elements tournament, softball tournament, video games tournament and volleyball tournament.

62. The system of claim 50 where said token is further redeemable for goods and services associated with said tournament.

63. The system of claim 62 wherein said goods and services are selected from the group consisting of: hotel reservations, flight reservations, car rentals, shuttle services, restaurant reservations, in-game services and event reservations.

64. The system of claim 50 further comprising steps of selling tokens for provision of goods and services to providers of said goods and services.

65. A computer implemented system for tournament ticketing, comprising:
a. a networked server in communication with a ticket requisitioning system;
b. software adapted to allow users to purchase tokens redeemable for tickets to all of the matches i of a contestant c in said tournament;
c. a user interface adapted to operate software;
d. a database of tickets bought, tokens sold and calculation performed;
e. a module adapted to generate tokens and provide said tokens to their purchasers.
f. a calculating engine adapted to maintain a relation between the number of tickets to buy as a function of the number of tokens bought and contestant advancement probabilities of P_{c,i} of a given contestant c reaching match i of said tournament, wherein the number of tickets bought is maintained at a level equal to the maximum pairwise sum of tokens sold times the advancement probabilities of the respective contestant, times a constant.

66. The computer implemented system of claim 65 further comprising a communication means adapted to connect third parties applications and networks to the system.
